(19) United States
(12) Patent Application Publication
(10) Pub. No.: US 2023/0229998 A1
(43) Pub. Date: Jul. 20, 2023

(54) METHODS AND SYSTEMS FOR ASSET MANAGEMENT USING CUSTOMIZED CALCULATION MODULE

(71) Applicant: Copperleaf Technologies Inc., Vancouver (CA)

(72) Inventor: Alejandro ERICKSON, Burnaby (CA)

(21) Appl. No.: 17/579,937

(22) Filed: Jan. 20, 2022

(51) Int. Cl. G06Q 10/06

(52) U.S. Cl. CPC G06Q 10/06313

(57) ABSTRACT

Systems and methods of an asset management system are provided herein may include a user facing feature configured to receive a first request for information associated with one or more assets being managed by the asset management system; and a calculation module including a generalized engine configured to determine and provide a customized formula machine (FM) to the user facing feature to obtain a requested output to respond to the first request for information, wherein the determined FM is configured to be instantiated as a persistent object associated with the user facing feature and configured to calculate formula outputs based on formula inputs provided to the FM, and wherein the user facing feature is further configured to consume the calculated formula outputs to generate a response to the first request and to subsequent requests with different formula inputs without using the calculation module and generalized engine to calculate the outputs.

### FIELD

The disclosure relates, generally, to methods and systems for asset management using a customized calculation module in an asset-management system.

### BACKGROUND

Many businesses face challenges handling capital planning for the assets they have under management. In order to make informed decisions the financial leaders need to understand how a change in a parameter(s) affects a project's target goal.

Customized calculators that used customized formulas may be used in capital planning and management software application and various user-facing features that consume calculated information. However, performance bottlenecks typically occur when similar difficult and time-consuming calculations are required repeatedly, even when changes to the input data are minor.

Accordingly, the inventors have provided methods and systems that use a customized calculation module in an asset-management system that mitigate performance bottlenecks and improve efficiency and throughput of customized calculation modules associated with asset management systems.

### SUMMARY

Systems and methods of an asset management system are provided herein. In some embodiments, an asset management system may include a user facing feature configured to receive a first request for information associated with one or more assets being managed by the asset management system; and a calculation module including a generalized engine configured to determine and provide a customized formula machine (FM) to the user facing feature to obtain a requested output to respond to the first request for information, wherein the determined FM is configured to be instantiated as a persistent object associated with the user facing feature and configured to calculate formula outputs based on formula inputs provided to the FM, and wherein the user facing feature is further configured to consume the calculated formula outputs to generate a response to the first request and to subsequent requests with different formula inputs without using the calculation module and generalized engine to calculate the outputs.

In another example, an asset management system including a flexible measure calculator (FMC) may further include a user facing feature configured to receive a first request for information associated with one or more assets being managed by the asset management system; and a calculation module including a generalized engine configured to determine a customized formula to obtain a requested output to respond to the first request for information, wherein the customized formula is configured to be instantiated as a persistent object within a memory of the calculation module, wherein the customized formula is configured to calculate formula outputs based on formula inputs provided to the customized formula, wherein formula inputs and formula outputs are stored within the customized formula instantiated persisted object, and wherein the user facing feature is further configured to access the customized formula instantiated persisted object to generate a response to the first request and to subsequent requests with different formula inputs.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 is a block diagram of an asset management system, in accordance with an embodiment of the disclosure;

FIG. 2 is the system's standard calculation module, in accordance with an embodiment of the disclosure;

FIG. 3 is the system's calculation module using the Formula Machine, in accordance with an embodiment of the disclosure;

FIG. 4 is the system's calculation module using the Flexible Measure Calculator, in accordance with an embodiment of the disclosure;

FIG. 5 is a flowchart of a method for asset management, in accordance with an embodiment of the disclosure;

FIG. 6 is a flowchart of a method for asset management, in accordance with an embodiment of the disclosure; and

FIG. 7 is a depiction of a computer system that can be utilized in various embodiments of the present invention.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

The following detailed description describes techniques (e.g., methods, processes, and systems) for using a customized calculation module in an asset-management system. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims.

In general, system 10 is a capital planning and management software application consisting of data, a calculation module 12, and various user-facing features 14 that consume calculated information. The software user 16 interacts with a user-facing feature 14, such as a capital investment forecasting tool, and in turn the feature displays a combination of data and calculations that take data as input. Examples of data are a list of capital investment projects under consideration, the properties and characteristics that describe those investment projects, and customized system 10 parameters such as inflation rates. In the forecasting tool example, the calculation module 12 might provide not only the forecasted capital expenditures, but also any risks and benefits of completing the investment project.

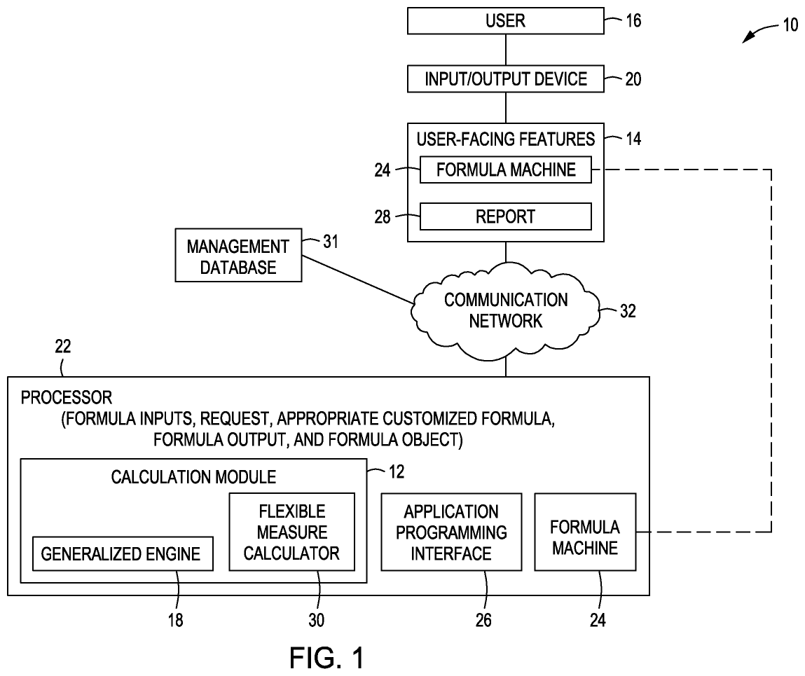

In some embodiments, each user 16 has a unique way of calculating risks and benefits that is implemented in a customized component of the user's 16 calculation module 12. The calculation module 12 consists of a generalized engine 18 that drives customized formulas as shown in FIG. 1. In some embodiments, generalized engine 18 is a separate engine module that receives calls (e.g., API calls, or other types of request for information) from the calculation module 12 to provide information. Each formula accepts as input some data that is collected and provided by the engine 18, and returns as output some calculated information, which may or may not be numerical. The calculated information is passed to the engine 18, and then passed to and consumed by a user-facing feature 14 via communication network 32. A partially customized calculation has several steps. The engine 18 selects the appropriate formula, packages the data into a generic formula input container, invokes the formula with the packaged inputs, and processes and stores the output. Each time data or information is exchanged between the engine 18 and the formula, it is reinterpreted in a generalized or customized context, which is computationally more expensive than the equivalent process in an entirely customized calculation module. Furthermore, a temporary formula object is created and destroyed for each formula invocation.

For example, suppose formula A calculates monthly spend amounts and takes as input a dollar amount of spend, a date, and some number of months to evenly spread the dollar amount over. Formula B calculates the probability of an event occurring in each month and takes as input a probability distribution function and a date. The engine 18 stores the inputs, which are of mixed type, in a generic container, and the formulas reinterpret them as specific types. Formula A outputs a list of dollar amounts that is immediately consumed by a user-facing feature 14, while formula B outputs a list of probabilities, which are repeatedly used by other formulas. The engine 18 cannot anticipate the differences in usage, so it effectively treats all formula output in a generic fashion as well. In particular, the engine 18 wraps the formula output in a generic container with some meta-data and stores it in memory. If the same formula output is requested again, the engine 18 can provide cached output, which is computationally less expensive than invoking the formula again, however it may be the case the formula output is stored and never requested again.

Suppose the output of formula A is requested for a different date, such that it should spread the same amount of spend over the same number of months but starting at a different date. The calculation engine 18 cannot interpret and modify its stored output, and thus it repeats the whole process of invoking formula A again. Similarly for requests to formula B which, by its nature as a statistical calculation, might be considerably more computationally expensive than formula A.

To summarize, the following operations occur at each formula invocation: the engine 18 packages the required data in a generic container and passes it to the invoked formula; the formula interprets the generic container of inputs as specific types of inputs and returns output to the engine; the engine provides the output to the user-facing feature 14 that requested it and stores it in memory regardless of whether or not it will be required again later.

In some embodiments, system 10 uses user-facing features 14 that make increasingly intensive use of the calculation module 12. These user-facing features 14 request formula output for the same investment (or similar entity) repeatedly but with small changes to the formula inputs, such as the date that a planned event will occur on. The steps described above may become a computational bottleneck in this scenario.

With reference to FIG. 1, in some embodiments consistent with the disclosure, the asset management system 10 includes an input/output 20 device. The system 10 also includes a processor 22, which in some embodiments is programmed to receive a request for information from a user 16 via an input/output device 20 and the request for information is provided to the user-facing feature 14 which creates requests related to a plurality of assets to be provided to a generalized engine 18, wherein the formula inputs are selected based upon the request related to the plurality of assets in a network, and wherein the generalized engine determines an appropriate customized formula based upon the request and the formula inputs; generate formula output via a calculations module 12 using the formula inputs in the appropriate customized formula determined and transmit the formula output to the generalized engine to store the formula output; and deliver to a user-facing feature 14 that consumes calculated information a formula machine (FM) 24, wherein the FM is a custom calculator received from the generalized engine 18 and the FM uses an application programming interface (API) 26 that is known to the appropriate customized formula and the user-facing feature, and the user-facing feature can generate a response 28, e.g. report, to the request without providing all the formula inputs to the FM and without using the calculations module, and the response is then transmitted to the input/output device.

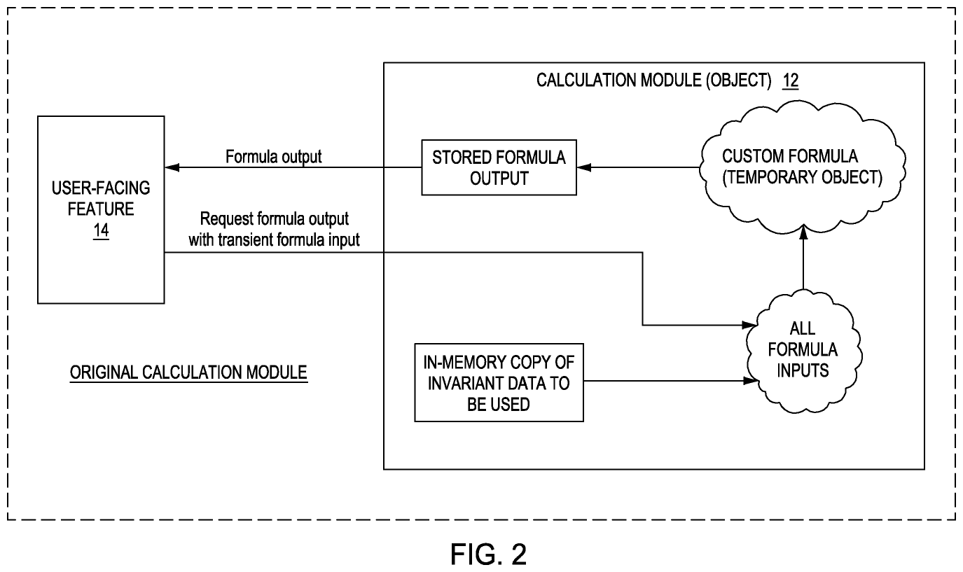

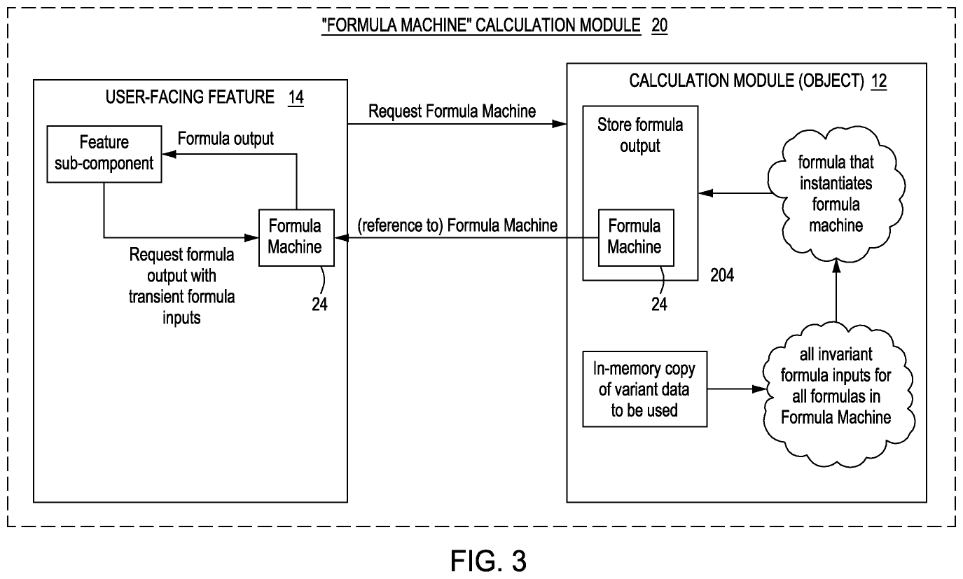

With additional reference to FIGS. 2 and 3, an example of system 10 integrating custom formulas with the generic engine 18 in the calculation module 12 is provided. For example, Formula Machine 24, employs a special formula whose inputs are the aggregate inputs of the user-specified plurality of formulas and whose output is an object capable of producing, on demand, the output of any other formula. That is, the user who programmed the custom formulas, specifies which formulas are going to be handled by a specific FM that is to be used by a specific feature. The user can specify one or more FMs for different uses.

The Formula Machine 24 effectively uses the existing calculation module 12 to pass a custom calculator directly to at least one user-facing feature 14 that consumes calculations, by which the calculation module is bypassed. This is achieved through an interface/API 26 that is known to both the formulas and the user-facing feature 14. The user-facing feature 14 requests formula output through the API 26 without providing the entire set of formula inputs. The user 16 via the user-facing feature 14 creates one or more custom implementations of the API 26 that are instantiated in a special “FM” formula objects and are passed to the engine 18 as formula output when the FM formula is invoked. The API 26 instance, here called the FM 24, is a persisted object (in the sense of object-oriented software) that contains, and can invoke, the logic of all formulas of interest, which were specified when the custom formulas were implemented.

As a simplified example, suppose that the API's 26 interface member for invoking a formula is as ‘double?[ ] GetValues(int startYear, int numMonths, long formulaId)’. The feature code can call ‘GetValues(startYear: 2021, numMonths: 120, formulaId: 1)’, for example, to obtain 10 years of monthly output for formulaId=1, starting in year 2021. The custom FM 24 implementation interprets ‘formulaId=1’, invokes the appropriate logic, and returns the output of that formula directly to the user-facing feature 14. Since the FM 24 continues to persist after this request, it can keep all or part of the results of the calculation it has just performed for future use, with the difference that this functionality is implemented with knowledge of what is being calculated, rather than without.

The above example is simplified in that GetValues may take additional parameters including a subset of formula inputs that can be adjusted from one invocation to the next. This allows formulas to calculate risks or benefits for small variations on the same investment project, while the unchanging majority of formula inputs are passed once to the FM 24 through the formula that created it, and then remain persisted in the FM until the FM is no longer referenced by the user-facing feature 14. The example also appears to suggest that a feature has a priori knowledge of a formulaId, which will not be the case in general. A formula is chosen for the feature by the user 16 through system configuration, and the feature queries the data for the formula's Id. Similarly for the startYear and numMonths parameters.

To summarize, the FM 24 is an API 26 object with a custom implementation, capable of persisting inputs and calculating outputs for any number of formulas of interest, as well as caching arbitrary intermediate calculations. It is used directly by the user-facing feature 14 that consumes the calculations.

In some embodiments, the generalized engine 18 packages the formula inputs with metadata in a generic container and passes it to the appropriate customized formula. The appropriate customized formula interprets the generic container of inputs as specific types of inputs and returns output to the generalized engine 18 and the generalized engine provides the output to the user-facing feature 14.

In some embodiments, the FM 24 is an object returned from a special formula whose inputs are an aggregate of all other formula inputs and whose output is an object capable of producing, on demand, the output of any other formula. More specifically, the FM object 24 is an instance of a class that implements a specific API known to the user-facing feature 14. The “special formula” takes the aggregate of required formula inputs and passes them to be persisted inside the FM object, which in turn can execute the logic of the (regular/normal) formulas the FM was programmed to emulate. In addition, any other formula as used above refers to a wider set of formulas that the FM was programmed to emulate. In other embodiments, the FM 24 is an API 26 object with a custom implementation, capable of persisting inputs and calculating outputs for any number of formulas of interest, as well as caching arbitrary intermediate calculations, and the FM is used directly by the user-facing feature 14 that uses any generated calculations.

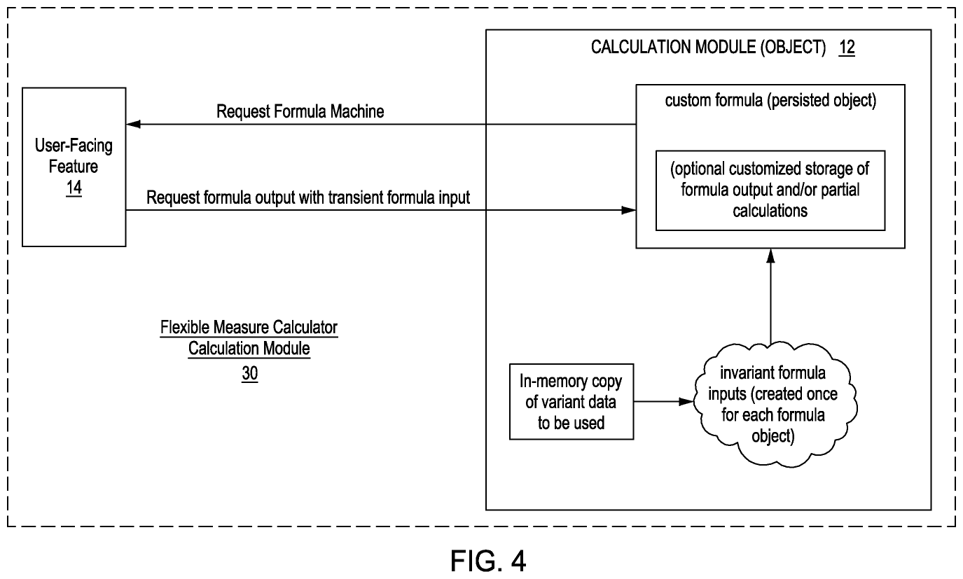

With additional reference to FIG. 4, another example of system 10 integrating custom formulas with the generic engine 18 in the calculation module 12 is provided. For example, Flexible Measure Calculator (FMC) 30, expands the responsibility of the formula, allowing it to persist as a (software) object that can arbitrarily store properties in memory and reuse them as necessary to calculate formula output. Also, in some embodiments the generalized engine's 18 capabilities are extended via the FMC 30.

In some embodiments, the Flexible Measure Calculator 30 does not bypass the engine 18, but it shifts the responsibility of storing formula output and most formula inputs onto the formula itself. Previously the engine 18 destroyed the formula object and stored the formula output after invoking a formula, but the FMC 30 stores the formula object, which in turn stores whatever it is programmed to store, possibly including partial or complete formula output. Furthermore, since most formula inputs are persisted in the formula, these are not packed and passed in repeatedly when a small subset of formula inputs are adjusted between repeated invocations. FMC 30 bears a similar set of advantages to FM 24, but it is also nearly transparent to the user-facing feature 14 code and existing custom formula implementations. That is, existing formula implementations and user-facing features 14 require little to no change to co-exist with FMC 30, whereas new formula implementations and user-facing features 14 can take advantage of the benefits of persisted formulas.

In some embodiments, the asset management system 10 includes an input/output 20 device; and a processor 22 programmed to: receive a request for information from a user 16 via an input/output device 20 and the request for information is provided to the user-facing feature 14 which creates requests related to a plurality of assets to be provided to a generalized engine 18, wherein the formula inputs are selected based upon the request related to the plurality of assets in a network, and wherein the generalized engine determines an appropriate customized formula based upon the request and the formula inputs;

generate formula output via a calculations module 12 using the formula inputs in the appropriate formula; and use a flexible measure calculator (FMC) 30 that enables the appropriate formula to store the formula outputs and formula inputs instead of the generalized engine by the FMC preserving a formula object that stores whatever the formula object was programmed to store so that the feature can generate a response 28 to the request and the response is then transmitted to the input/output device.

In some embodiments, the generalized engine 18 packages the formula inputs with metadata in a generic container and passes it to the appropriate formula. In other embodiments, the appropriate formula interprets the generic container of inputs as specific types of inputs and returns output to the generalized engine 18 and the generalized engine provides the output to the user-facing feature 14.

In some embodiments, the FMC 30 stores most formula inputs and partial or complete formula output. In other embodiments, the formula inputs are persisted in the appropriate formula and are not packed and passed in repeatedly when a small subset of formula inputs are adjusted between repeated invocations.

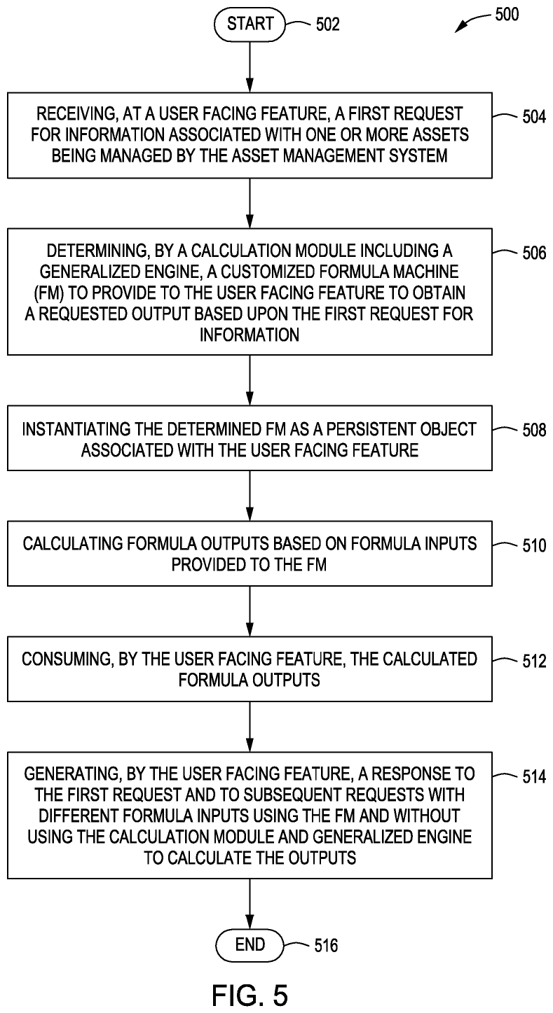

FIG. 5 depicts a method 500 for calculating and providing information associated with one or more assets being managed by an asset management system. The method 500 begins at 502. At 504, a first request for information associated with one or more assets being managed by the asset management system is received at the user facing feature 14. In some embodiments, this may include receiving a request for information from a user via an input/output device and the request for information is provided to the user facing feature which creates requests related to a plurality of assets to be provided to a generalized engine, wherein the formula inputs are selected based upon the request related to the plurality of assets in a network, and wherein the generalized engine determines an appropriate customized formula based upon the request and the formula inputs.

At 506 of FIG. 5, a customized formula machine (FM) 24 to provide to the user facing feature 14 to obtain a requested output based upon the first request for information is determined by a calculation module 12 including a generalized engine 18. In some embodiments, the method 500 may also include generating formula output via the calculations module 12 using the formula inputs in the appropriate customized formula determined and transmit the formula output to the generalized engine to store the formula output.

The method proceeds to 508 where the determined FM is instantiated as a persistent object associated with the user facing feature, and then to 510 where formula outputs are calculated based on formula inputs provided to the FM. At 512, the calculated formula outputs are consumed by the user facing feature 14. The method proceeds to 514 where a response to the first request and to subsequent requests with different formula inputs are generated by the user facing feature using the FM and without using the calculation module and generalized engine to calculate the outputs. The method 500 ends at 516.

In some embodiments, the method may further include delivering to a user-facing feature that consumes calculated information, a formula machine (FM), wherein the FM is a custom calculator received from the calculations module and the FM uses an application programming interface (API) that is known to the appropriate customized formula and the user-facing feature, and the user-facing feature can generate a response to the request without providing all the formula inputs to the FM and without using the calculations module, and the response is then transmitted to the input/output device.

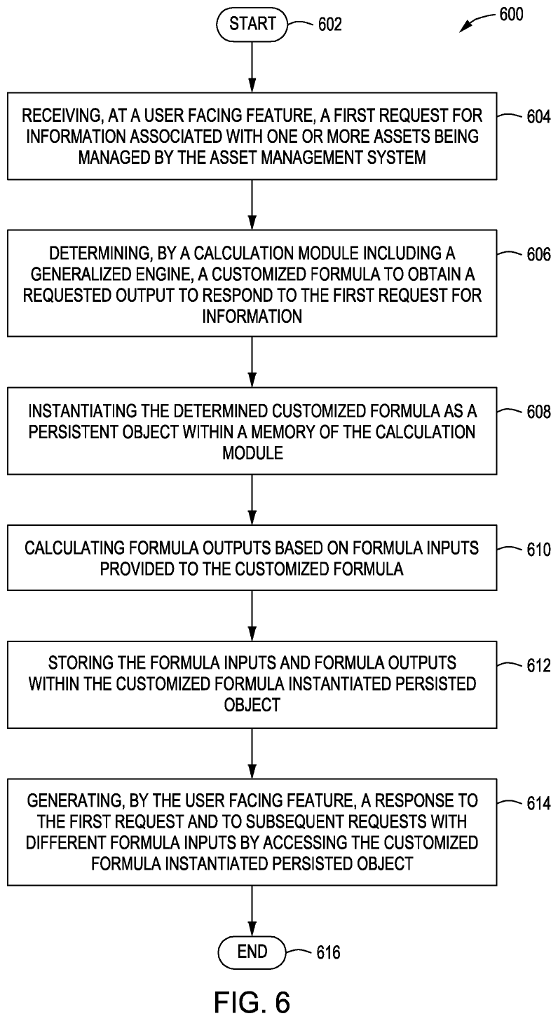

FIG. 6 depicts a method 600 for calculating and providing information associated with one or more assets being managed by an asset management system including a flexible measure calculator (FMC). The method 600 begins at 602. At 604, a first request for information associated with one or more assets being managed by the asset management system is received at the user facing feature 14. At 606, a customized formula to obtain a requested output to respond to the first request for information is determined by a calculation module 12 including a generalized engine 18. At 608, the determined customized formula instantiated as a persistent object within a memory of the calculation module. At 610, formula outputs are calculated based on formula inputs provided to the customized formula. The formula inputs and formula outputs are stored within the customized formula instantiated persisted object at 612. Finally, at 614, a response to the first request and to subsequent requests with different formula inputs by accessing the customized formula instantiated persisted object is generated by the user facing feature. The method 600 ends at 616.

In some embodiments, the method may include receiving formula inputs via an input/output device in a generalized engine, the formula inputs selected based upon a request for a plurality of assets in a network, and the generalized engine invokes an appropriate formula based upon the request and the formula inputs. The method may also include generating formula output via a calculations module using the formula inputs in the appropriate formula. The method may further include using a flexible measure calculator (FMC) that enables the appropriate formula to store the formula outputs and formula inputs instead of the generalized engine by the FMC preserving a formula object that stores whatever the formula object was programmed to store so that the feature can generate a response to the request and the response is then transmitted to the input/output device.

Both method 500 using the FM 24, and method 600 using FMC 30, greatly reduce the frequency with which we instantiate formula objects and package formula inputs when the same formula is invoked on the same investment (or similar entity) repeatedly with minor changes. It also allows arbitrary partial computations to be stored, which can be chosen strategically by the implementer of the formula to yield the highest performance improvement. Finally, FM 24 and FMC 30 do not reduce the performance of the calculation module 12 in any existing use case.

In some embodiments, the FM 24 and the FMC 30 are designed to improve performance when the same formula calculation code is invoked repeatedly with similar inputs. For example, the contribution of the FM 24 and FMC 30 is that they enable a level of scalability and quality of solution that was not previously available in an existing software system.

In some embodiments, an intensive use of formula calculations comes from scheduling algorithms based on some variant of local search. For instance, the user 16 has a population of assets, whose records are stored in the software's 10 database 31, and the user's goal is to determine what to do with each asset over a 50 year period, given some budgetary, resource, or other constraints. The solution comes in the form of a chronological sequence of “interventions” for each asset. An intervention can be a replacement, a refurbishment, or any number of other ways you can make an impact on a physical asset. Examples of assets, interventions, and value measures (which are ultimately computed by formulas) are given below, followed by more details on the above referenced local search.

For example, a hydro turbine undergoes surface cavitation, and after a number of operating hours, or a certain age, it requires resurfacing. When a turbine reaches the end of its expected life it must be replaced. Usually asset records in system's 10 software represent the functional role of the asset, so the (future) replacement turbine also replaces the asset record in the system. The replacement turbine may differ from the original, such as through technology improvement, which may affect calculations. Each of these interventions, resurfacing and replacement, impact the condition of the turbine, and possibly the condition degradation model going forward from the date of intervention. The condition at impact and condition degradation model can be used to calculate probabilities of failure which are used to assess risk. Or in a more complex asset model, multiple condition indices, and probabilities of more than one failure mode, each with its own consequence.

Further, power generation assets are often associated with a “lost generation risk” value measure that accounts for power that must be bought to make up for what cannot be generated, but dozens of other values measures may also apply. Conceivably, system 10 might forecast water levels, power generated by wind, power consumption, all of which affect the consequence of this asset's inability to generate power at any given moment. Additionally, system 10 may model multiple failure modes and the degradation of conditions of more than one part of the asset (bearings, blades, surfaces, etc.), and those failures may result in outage and repair, degraded operation, or catastrophe. Some of those failure and consequence models are straightforward applications of statistical distributions such as Weibull distribution, and others may result from more intensive on-the-fly computations such as those employing Monte Carlo methods, Machine Learning, fitting/regressing statistical models to data, etc.

Similar to hydro turbines, combustion turbines require certain interventions after a number of operating hours, and also cold startups. These, especially startups, are also affected by the availability of renewable power, weather, consumption, etc.

Consider now the local search, mentioned above, as it applies to a hydro turbine. At each iteration, the search proposes a sequence of interventions for the hydro turbine, for example, resurface in 2035, replace in 2050, and resurface again in 2065 (The granularity of the schedule may be coarser or finer, but in this example it is assumed yearly). Performing iterations, and therefore calculating formulas, efficiently is a key component to producing high quality feasible solutions to the constrained scheduling optimization problem at hand. The proposed sequence serves as partial input to several formulas that compute probabilities of failure for a variety of failure modes (catastrophic failure, repeated minor issues, etc.), which also take into account other maintenance history, asset nameplate data, etc. Some of those probability models may require an intensive computation that can be simplified with knowledge of what is being calculated. For example, the model for catastrophic failure following a replacement (up to the next intervention) may simply be a time-shifted translation from a replacement on a different date (or it may also not be), and if the system 10 knows this to be the case the system can reuse probability calculations where it previously could not without writing code into the generic calculation model that accounts for this special and, most significantly, custom case. Probabilities are often multiplied by monetary consequences to calculate risks, and similarly the consequences may be expensive to compute and may change depending on the type and date of the intervention. With knowledge of what is being calculated, system 10 can again make savings by pre-calculating and storing some part of the calculation.

Another use case that may require intensive calculations is to subject a scheduling optimization problem and solver to a multi-dimensional sensitivity analysis. Suppose that, instead of an asset, an investment project is the unit that a formula calculation applies to, and that the investment can be carried out in one of several “alternative” ways, for example, on different dates. Again, a scheduling problem arises when a set of investments compete for resources over a period of time. It may also occur that some external parameter is difficult to predict, such as inflation rates, interest rates, energy prices, oil prices, or discount rates, and the user 16 would like to try out a wide variety of combinations of scenarios in these different dimensions. The “alternative” is similar to an intervention occurring on a date, and it has an impact characterized by formula inputs specific to itself. These are, as with interventions, the partial inputs that may change the formula calculation somewhat, but not necessarily completely. System 10 can add inputs here that describe an external parameter, and vary them automatically with software in order to report on and analyze the sensitivity of the schedule optimization to the parameters. Once again, the FM 24 and the FMC 30 give us more flexibility to separate expensive partial computation from the external parameters system 10 is analyzing.

System 10 software has customizable reports 28, e.g. response, which tend to have some commonalities. The results of a schedule optimization can evidently be reported as chronological sequences of interventions, but users 16 often want to see the same value measures that were used during the local search (or optimization or other computation) aggregated over the investment projects or the assets that were analyzed. For example, if a set of hydro turbines is analyzed, and a scheduled is calculated for them, each turbine will have some “lost generation risk” occurring over the analysis horizon. The user 16 would typically want to see the total lost generation risk aggregated over all of the turbines that were analyzed, along with other value measures that were used. Another view might aggregate the value measure amounts occurring over time into one value, considering each value measure as a cost or a benefit, so as to report 28 the total value of the schedule. In the case of local search in particular, multiple solutions are visited (one per iteration), and the user 16 might want to see the progression of total values achieved over the course of the search. Finally, where aggregate value measure amounts are subjected to constraints (resource or otherwise, and possibly different in each year or time-step), the user 16 can compare the aggregate value measure amounts of the solution to the amounts allowed by the constraints.

There are hundreds of different asset types, value measures, and ways to calculate risks, probabilities, costs, and every other conceivable thing about them. Likewise there are many conceivable ways to consume formula calculations. As a result, system 10 is able to decouple the custom calculations from the software product that consumes the calculations, thereby providing more flexibility and increasing the sophistication of both.

In one embodiment, the system 10 communicates over a communications network 32, which enables a signal to travel anywhere within system 10 and/or to any other component/system connected to the apparatus. The communications network 32 is wired and/or wireless, for example. The communications network 32 is local and/or global with respect to system 10, for instance.

FIG. 8 is a depiction of a computer system/apparatus 10 that can be utilized in various embodiments of the invention. The computer system 10 comprises substantially similar structure comprising servers or electronic devices in the aforementioned embodiments.

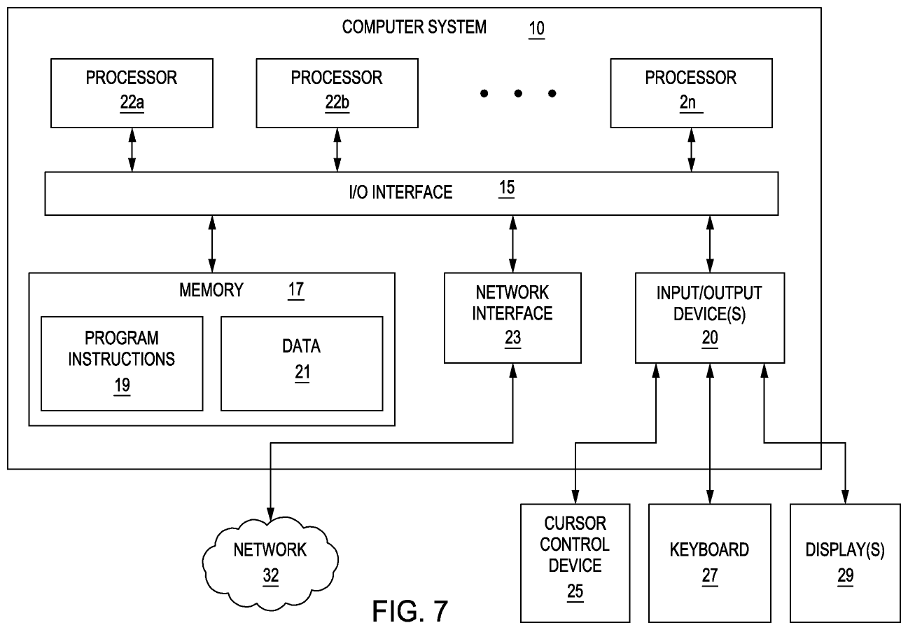

Various embodiments of methods and system for routing active communication session data, as described herein, may be executed on one or more computer systems, which may interact with various other devices. One such computer system is computer system 10 illustrated by FIG. 8, which may in various embodiments implement any of the elements or functionality illustrated in FIGS. 1-7. In various embodiments, computer system 10 may be configured to implement methods described above. The computer system 10 may be used to implement any other system, device, element, functionality or method of the above-described embodiments. In the illustrated embodiments, computer system 10 may be configured to implement methods 500 and 600 as processor-executable executable program instructions 19 (e.g., program instructions executable by processor(s) 22) in various embodiments.

In the illustrated embodiment, computer system 10 includes one or more processors 22a-22n coupled to a system memory 17 via an input/output (I/O) interface 15. Computer system 10 further includes a network interface 23 coupled to I/O interface 15, and one or more input/output devices 20, such as cursor control device 25, keyboard 27, and display(s) 29. In some embodiments, the keyboard 27 may be a touchscreen input device.

In various embodiments, any of the components may be utilized by the system 10 to route active communication session data described above. In various embodiments, a user interface may be generated and displayed on display 29. In some cases, it is contemplated that embodiments may be implemented using a single instance of computer system 10, while in other embodiments multiple such systems, or multiple nodes making up computer system 10, may be configured to host different portions or instances of various embodiments. For example, in one embodiment some elements may be implemented via one or more nodes of computer system 10 that are distinct from those nodes implementing other elements. In another example, multiple nodes may implement computer system 10 in a distributed manner.

In different embodiments, computer system 10 may be any of various types of devices, including, but not limited to, personal computer systems, mainframe computer systems, handheld computers, workstations, network computers, application servers, storage devices, a peripheral device such as a switch, modem, router, or in general any type of computing or electronic device.

In various embodiments, computer system 10 may be a uniprocessor system including one processor 22, or a multiprocessor system including several processors 22 (e.g., two, four, eight, or another suitable number). Processors 22 may be any suitable processor capable of executing instructions. For example, in various embodiments processors 22 may be general-purpose or embedded processors implementing any of a variety of instruction set architectures (ISAs). In multiprocessor systems, each of processors 22 may commonly, but not necessarily, implement the same ISA.

System memory 17 may be configured to store program instructions 19 and/or data 21 accessible by processor 22. In various embodiments, system memory 17 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 17. In other embodiments, program instructions and/or data may be received, sent or stored upon different types of computer-accessible media or on similar media separate from system memory 17 or computer system 10.

In one embodiment, I/O interface 15 may be configured to coordinate I/O traffic between processor 22, system memory 17, and any peripheral devices in the device, including network interface 23 or other peripheral interfaces, such as input/output devices 20. In some embodiments, I/O interface 15 may perform any necessary protocol, timing or other data transformations to convert data signals from one component (e.g., system memory 17) into a format suitable for use by another component (e.g., processor 22). In some embodiments, I/O interface 15 may include support for devices attached through various types of peripheral buses, such as a variant of the Peripheral Component Interconnect (PCI) bus standard or the Universal Serial Bus (USB) standard, for example. In some embodiments, the function of I/O interface 15 may be split into two or more separate components, such as a north bridge and a south bridge, for example. Also, in some embodiments some or all of the functionality of I/O interface 15, such as an interface to system memory 17, may be incorporated directly into processor 22.

Network interface 23 may be configured to allow data to be exchanged between computer system 10 and other devices attached to a network (e.g., network 32), such as one or more external systems or between nodes of computer system 10. In various embodiments, network 32 may include one or more networks including but not limited to Local Area Networks (LANs) (e.g., an Ethernet or corporate network), Wide Area Networks (WANs) (e.g., the Internet), wireless data networks, cellular networks, Wi-Fi, some other electronic data network, or some combination thereof. In various embodiments, network interface 23 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 20 may, in some embodiments, include one or more display terminals, keyboards, keypads, touchpads, touchscreens, scanning devices, voice or optical recognition devices, or any other devices suitable for entering or accessing data by one or more computer systems 10. Multiple input/output devices 20 may be present in computer system 10 or may be distributed on various nodes of computer system 10. In some embodiments, similar input/output devices may be separate from computer system 10 and may interact with one or more nodes of computer system 10 through a wired or wireless connection, such as over network interface 23.

In some embodiments, the illustrated computer system may implement any of the methods described above, such as the methods illustrated by the flowcharts of FIGS. 5 and 6. In other embodiments, different elements and data may be included.

Those skilled in the art will appreciate that computer system 10 is merely illustrative and is not intended to limit the scope of embodiments. In particular, the computer system and devices may include any combination of hardware or software that can perform the indicated functions of various embodiments, including computers, network devices, Internet appliances, smartphones, tablets, PDAs, wireless phones, pagers, and the like. Computer system 10 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 10 may be transmitted to computer system 10 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the invention, other and further embodiments of the invention may be devised without departing from the basic scope thereof, and the scope thereof is determined by the claims that follow.

1. An asset management system comprising:
a user facing feature configured to receive a first request for information associated with one or more assets being managed by the asset management system; and
a calculation module including a generalized engine configured to determine and provide a customized formula machine (FM) to the user facing feature to obtain a requested output to respond to the first request for information,
wherein the determined FM is configured to be instantiated as a persistent object associated with the user facing feature and configured to calculate formula outputs based on formula inputs provided to the FM, and
wherein the user facing feature is further configured to consume the calculated formula outputs to generate a response to the first request and to subsequent requests with different formula inputs without using the calculation module and generalized engine to calculate the outputs.

2. The asset management system of claim 1, wherein the generalized engine packages or aggregates the formula inputs with metadata in a generic container and passes it to the FM to be instantiated as a persistent object associated with the user facing feature.

3. The asset management system of claim 2, wherein the FM interprets the generic container of inputs as specific types of inputs and returns output to be consumed by the user facing feature.

4. The asset management system of claim 1, wherein the FM is an object returned from a special formula determined by the calculation module whose inputs are an aggregate of all other formula inputs and whose output is an object capable of producing, on demand, the output of any other formula.

5. The asset management system of claim 1, wherein the FM is an API object with a custom implementation, capable of persisting inputs and calculating outputs for any number of formulas of interest, as well as caching arbitrary intermediate calculations, and the FM is used directly by the feature that uses any generated calculations.

6. The asset management system of claim 1, wherein the formula inputs are persisted in the determined FM and are not packed and passed in repeatedly when a subset of formula inputs are adjusted between repeated invocations.

7. An asset management system including a flexible measure calculator (FMC), comprising:
a user facing feature configured to receive a first request for information associated with one or more assets being managed by the asset management system; and
a calculation module including a generalized engine configured to determine a customized formula to obtain a requested output to respond to the first request for information,
wherein the customized formula is configured to be instantiated as a persistent object within a memory of the calculation module,
wherein the customized formula is configured to calculate formula outputs based on formula inputs provided to the customized formula,
wherein formula inputs and formula outputs are stored within the customized formula instantiated persisted object, and
wherein the user facing feature is further configured to access the customized formula instantiated persisted object to generate a response to the first request and to subsequent requests with different formula inputs.

8. The asset management system of claim 7, wherein the generalized engine packages the formula inputs with metadata in a generic container and passes it to the determined customized formula.

9. The asset management system of claim 8, wherein the determined customized formula interprets the generic container of inputs as specific types of inputs and returns output to the generalized engine and the generalized engine provides the output to the user facing feature.

10. The asset management system of claim 7, wherein the FMC enables the persistence of formula inputs and partial or complete formula output in persisted customized formula object instances.

11. The asset management system of claim 7, wherein the formula inputs are persisted in the appropriate formula and are not packed and passed in repeatedly when a subset of formula inputs are adjusted between repeated invocations.

12. A method for calculating and providing information associated with one or more assets being managed by an asset management system, comprising:
receiving, at a user facing feature, a first request for information associated with one or more assets being managed by the asset management system;
determining, by a calculation module including a generalized engine, a customized formula machine (FM) to provide to the user facing feature to obtain a requested output based upon the first request for information;
instantiating the determined FM as a persistent object associated with the user facing feature;
calculating formula outputs based on formula inputs provided to the FM,
consuming, by the user facing feature, the calculated formula outputs; and
generating, by the user facing feature, a response to the first request and to subsequent requests with different formula inputs using the FM and without using the calculation module and generalized engine to calculate the outputs.

13. The method of claim 12, wherein the generalized engine packages or aggregates the formula inputs with metadata in a generic container and passes it to the FM to be instantiated as a persistent object associated with the user facing feature.

14. The method of claim 13, wherein the FM interprets the generic container of inputs as specific types of inputs and returns output to be consumed by the user facing feature.

15. The method of claim 12, wherein the FM is an object returned from a special formula determined by the calculation module whose inputs are an aggregate of all other formula inputs and whose output is an object capable of producing, on demand, the output of any other formula.

16. The method of claim 12, wherein the FM is an API object with a custom implementation, capable of persisting inputs and calculating outputs for any number of formulas of interest, as well as caching arbitrary intermediate calculations, and the FM is used directly by the feature that uses any generated calculations.

17. The method of claim 12, wherein the formula inputs are persisted in the determined FM and are not packed and passed in repeatedly when a subset of formula inputs are adjusted between repeated invocations.

18. A method for calculating and providing information associated with one or more assets being managed by an asset management system including a flexible measure calculator (FMC), comprising:
receiving, at a user facing feature, a first request for information associated with one or more assets being managed by the asset management system;
determining, by a calculation module including a generalized engine, a customized formula to obtain a requested output to respond to the first request for information;
instantiating the determined customized formula as a persistent object within a memory of the calculation module;
calculating formula outputs based on formula inputs provided to the customized formula,
storing the formula inputs and formula outputs within the customized formula instantiated persisted object; and
generating, by the user facing feature, a response to the first request and to subsequent requests with different formula inputs by accessing the customized formula instantiated persisted object.

19. The method of claim 18, wherein the generalized engine packages the formula inputs with metadata in a generic container and passes it to the determined customized formula.

20. The method of claim 19, wherein the determined customized formula interprets the generic container of inputs as specific types of inputs and returns output to the generalized engine and the generalized engine provides the output to the user facing feature.

21. The method of claim 18, wherein the FMC stores most formula inputs and partial or complete formula output.

22. The method of claim 18, wherein the formula inputs are persisted in the determined customized formula and are not packed and passed in repeatedly when a small subset of formula inputs are adjusted between repeated invocations.

23. The method of claim 18, wherein the formula inputs are persisted in the appropriate formula and are not packed and passed in repeatedly when a subset of formula inputs are adjusted between repeated invocations.
